(19) United States
(12) Patent Application Publication
(10) Pub. No.: US 2017/0113318 A1
(43) Pub. Date: Apr. 27, 2017

(54) GRINDING TABLE APPARATUS, LIQUID CRYSTAL DISPLAY GLASS GRINDER AND GRINDING METHOD

(71) Applicants: BOE TECHNOLOGY GROUP CO., LTD., Beijing (CN); BEIJING BOE DISPLAY TECHNOLOGY CO., LTD., Beijing (CN)

(72) Inventors: Yajie SHAN, Beijing (CN); Bin WANG, Beijing (CN); Aiben FANG, Beijing (CN); Huan LIU, Beijing (CN); Lei BAI, Beijing (CN); Zhan GUO, Beijing (CN)

(21) Appl. No.: 15/231,968

(22) Filed: Aug. 9, 2016

(30) Foreign Application Priority Data
Oct. 22, 2015 (CN) 201510696927.8

(51) Int. Cl. B24B 9/08; G02F 1/13; B24B 41/06

(52) U.S. Cl. CPC B24B 9/08; B24B 41/068; G02F 1/1303

(57) ABSTRACT

A grinding table apparatus, liquid crystal display glass grinder and grinding method are disclosed, the apparatus including, a liftable central platform, a liftable outer-ring platform provided with a hollow slot, and a peripheral platform, the central platform being in the hollow slot of the outer-ring platform, and at one side of the peripheral platform together with the outer-ring platform, when the central platform is lifted to be coplanar with the peripheral platform, fixedly installing a first panel on the central platform, moving the peripheral platform to make an edge of the first panel exposed out, when the central platform and the outer-ring platform are both lifted to be coplanar with the peripheral platform, fixedly installing a second panel on the central platform and the outer-ring platform, moving the peripheral platform to make an edge of the second panel exposed out, the first panel being smaller than the second panel.

### CROSS REFERENCE TO RELATED APPLICATIONS

This application claims the benefit of Chinese Patent Application No. 201510696927.8 filed Oct. 22, 2015, which is hereby incorporated by reference in its entirety.

### BACKGROUND

Embodiments of the disclosure relate to the field of manufacturing liquid crystal displays, more particularly, to a grinding table apparatus, a liquid crystal display glass grinder and a grinding method.

During the manufacturing of liquid crystal display panels, it is needed to use a liquid crystal display glass grinder to grind and process edges of the liquid crystal panels, so as to remove burrs on the edges of the liquid crystal panels.

In the prior art, a liquid crystal display glass grinder has two grinding tables. One is a big-sized grinding table, for grinding big-sized liquid crystal display panels, and the other is a small-sized grinding table, for grinding small-sized liquid crystal display panels.

The inventors found that the prior art technique has at least the following problems. When it is needed to grind small-sized liquid crystal display panels, the big-sized grinding table needs to be removed from the liquid crystal display glass grinder and the small-sized grinding table needs to be installed on the liquid crystal display glass grinder manually. When it is needed to grind big-sized liquid crystal display panels, the small-sized grinding table needs to be removed from the liquid crystal display glass grinder and the big-sized grinding table needs to be installed on the liquid crystal display glass grinder manually. Such manual replacement of grinding tables of different sizes affects the manufacturing efficiency.

### BRIEF DESCRIPTION

In order to solve the problem of the prior art, embodiments of the disclosure provide a grinding table apparatus, the grinding table apparatus including a liftable central platform, a liftable outer-ring platform, and a peripheral platform.

The outer-ring platform is provided with a hollow slot, and the central platform can be in the hollow slot of the outer-ring platform, the central platform and the outer-ring platform being at one side of the peripheral platform.

When the central platform is lifted to be coplanar with the peripheral platform, a first panel can be fixedly installed on the central platform, and the peripheral platform can be moved to make an edge of the first panel exposed out of the peripheral platform.

When the central platform and the outer-ring platform are both lifted to be coplanar with the peripheral platform, a second panel can be fixedly installed on the central platform and the outer-ring platform, and the peripheral platform can be moved to make an edge of the second panel exposed out of the peripheral platform, the first panel being smaller than the second panel.

Optionally, the outer-ring platform includes a lifting device and a first platform. The lifting device is for lifting the first platform.

One end of the lifting device is fixed on a bottom surface of the first platform, and the other end thereof is fixed on a rotating base of a liquid crystal display glass grinder.

The lifting device is for lifting the first platform.

Optionally, the lifting device includes a screw rod and a motor.

One end of the screw rod is fixed on the bottom surface of the first platform, and the other end thereof is fixed on the rotating base of the liquid crystal display glass grinder and connected to the motor, the motor being fixed on the rotating base.

The motor can drive the screw rod to move upwards and downwards, such that the screw rod lifts or lowers the first platform.

Optionally, the lifting device is a pneumatic cylinder.

One end of the pneumatic cylinder is fixed on the bottom surface of the first platform, and the other end thereof is fixed on the rotating base of the liquid crystal display glass grinder.

The first platform can be lifted or lowered by controlling the air-intake or exhaust of the pneumatic cylinder.

Optionally, the pneumatic cylinder is enclosed in a water-proof bag.

Optionally, the number of the pneumatic cylinders is at least two.

the at least two pneumatic cylinders are evenly distributed and fixed on the bottom surface of the first platform.

Optionally, the central platform is circular, and the side of the peripheral platform adjacent to the central platform is provided with an arc slot.

when the central platform is lifted to be coplanar with the peripheral platform, the arc slot of the peripheral platform matches with the circular central platform.

Optionally, the hallow slot of the outer-ring platform is a circular slot.

when the central platform and the outer-ring platform are both lifted to be coplanar with the peripheral platform, the circular central platform is in the circular slot of the outer-ring platform.

Optionally, the number of peripheral platforms is two, which are a first peripheral platform and a second peripheral platform respectively.

The central platform and the outer-ring platform are located between the first peripheral platform and the second peripheral platform.

Optionally, the central platform, the outer-ring platform and the peripheral platform are provided with a plurality of holes.

In another aspect, embodiments of the disclosure provide a liquid crystal display glass grinder, and the liquid crystal display glass grinder includes the grinding table apparatus.

In another aspect, embodiments of the disclosure provide a grinding method of the grinding table apparatus, and the method is used to grind a first panel and a second panel, the first panel being smaller than the second panel, including, when the first panel is grinded, lifting a central platform of the grinding table apparatus is to be coplanar with an peripheral platform of the grinding table apparatus, fixedly installing the first panel on the central platform, moving the peripheral platform to make an edge of the first panel exposed out of the peripheral platform, and grinding the edge of the first panel.

when the second panel is grinded, lifting an outer-ring platform and the central platform of the grinding table apparatus to be coplanar with the peripheral platform, fixedly installing the second panel on the central platform and the outer-ring platform, moving the peripheral platform to make an edge of the second panel exposed out of the peripheral platform, and grinding the edge of the second panel.

The technical solutions provided by embodiments of the disclosure bring about the advantageous effects as follows, by configuring both of the central platform and the outer-ring platform of the grinding table apparatus as liftable platforms and providing a hollow slot in the outer-ring platform, when the first panel is grinded, the central platform is lifted to be coplanar with the peripheral platform, in which case the grinding table is the central platform and is a small grinding table when the second panel is grinded, the outer-ring platform and the central platform are lifted to be coplanar with the peripheral platform, in which case, the central platform and the outer-ring platform form a big grinding table. Thus, it is not needed to remove and install the grinding table manually when replacing the big-sized and small-sized grinding tables, and automatic switching between the big-sized and small-sized grinding tables can be accomplished by lifting and lowering the central platform and the outer-ring platform, thus enhancing the manufacturing efficiency.

### BRIEF DESCRIPTION OF THE DRAWINGS

In order to describe the technical solutions of embodiments of the disclosure more clearly, in the following will be briefly described the accompanying drawings used in the description of the embodiments of the disclosure. Obviously, the accompanying drawings in the following description are merely some embodiments of the disclosure. To those of ordinary skill in the art, other accompanying drawings may also be obtained according to these accompanying drawings without paying any creative effort.

FIG. 1 is a main view of a liquid crystal display glass grinder provided by an embodiment of the disclosure;

FIG. 2 is a top view of an outer-ring platform provided by an embodiment of the disclosure;

FIG. 3 is a top view when the central platform, the outer-ring platform and the peripheral platform are coplanar provided by an embodiment of the disclosure;

FIG. 4 is a top view when the central platform and the peripheral platform are coplanar provided by an embodiment of the disclosure;

FIG. 5 is a top view when the central platform, the outer-ring platform and two peripheral platforms are coplanar provided by embodiment of the disclosure;

FIG. 6 is a top view when the central platform and two peripheral platforms are coplanar provided by an embodiment of the disclosure;

FIG. 7 is a flow chart of a grinding method of the grinding table apparatus provided by an embodiment of the disclosure.

### DETAILED DESCRIPTION

To make the advantages of the disclosure more clear, in the following will be described in detail embodiments of the disclosure in conjunction with the accompanying drawings.

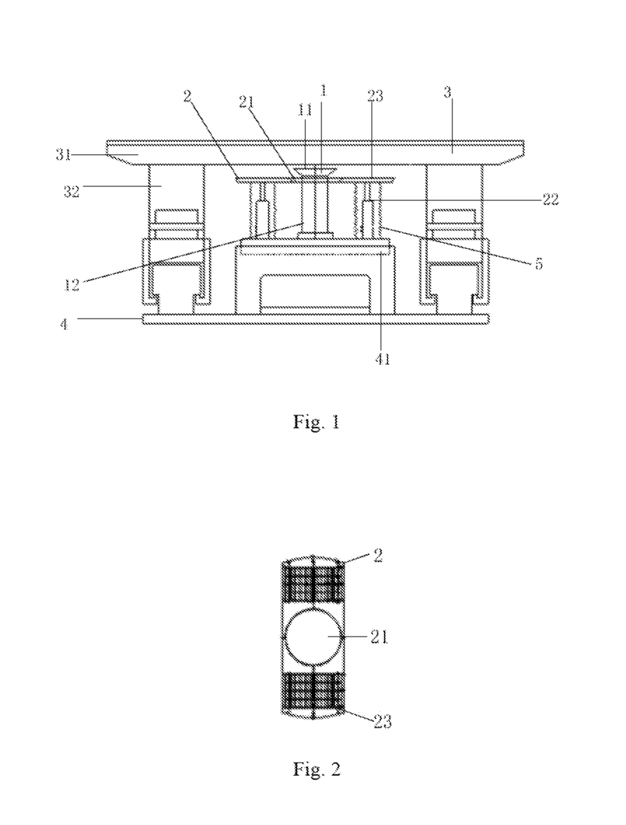

As shown in FIG. 1, embodiments of the disclosure provide a grinding table apparatus, and the grinding table apparatus includes, a liftable central platform 1, a liftable outer-ring platform 2, and a peripheral platform 3.

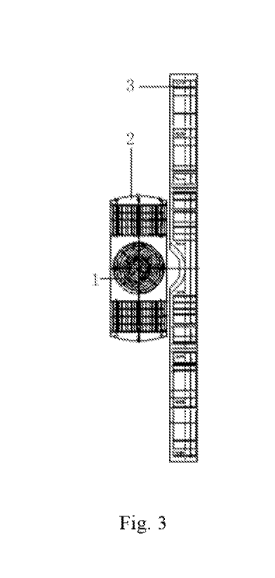

As shown in FIG. 2, the outer-ring platform 2 is provided with a hollow slot 21; as shown in FIG. 3, the central platform 1 is in the hollow slot 21 of the outer-ring platform 2, and the central platform 1 and the outer-ring platform 1 are located at one side of the peripheral platform 3.

When the central platform 1 is lifted to be coplanar with the peripheral platform 3, a first panel is fixedly installed on the central platform 1, and the peripheral platform 3 is moved to make an edge of the first panel exposed out of the peripheral platform 3.

when the central platform 1 and the outer-ring platform 2 are both lifted to be coplanar with the peripheral platform 3, a second panel is fixedly installed on the central platform 1 and the outer-ring platform 2, and the peripheral platform 3 is moved to make an edge of the second panel exposed out of the peripheral platform 3, the first panel being smaller than the second panel.

In an embodiment of the disclosure, the central platform 1 and the outer-ring platform 2 of the grinding table apparatus both may be liftable platforms, and the outer-ring platform 2 is provided with a hallow slot 21, when the first panel is to be grinded, the central platform 1 is lifted to be coplanar with the peripheral platform 3, at which time the grinding table is the central platform 1 and is a small-sized grinding table, when the second panel is to be grinded, the outer-ring platform 2 and the central platform 1 are lifted to be coplanar with the peripheral platform 4, at which time the central platform 1 and the outer-ring platform 2 form a big-sized grinding table. Thus, it is not needed to remove and install the grinding table manually when replacing the small-sized and big-sized grinding tables, and the automatic switch between the big-sized grinding table and the small-sized grinding table can be accomplished by just lifting and lowering the central platform 1 and the outer-ring platform 2, thus enhancing the manufacturing efficiency.

In an embodiment of the disclosure, as shown in FIG. 1, the grinding table apparatus is an important component of a liquid crystal display glass grinder 4, the liquid crystal display glass grinder 4 further includes a rotating base 41, and the central platform 1 and the outer-ring platform 2 are fixed on the rotating base 41.

In this embodiment, first the liquid crystal display glass grinder 4 may be used to grind a first panel with a small size, and then a second panel with a big size may be grinded. Alternatively, first the liquid crystal display glass grinder 4 may be used to grind a second panel with a big size, and then a first panel with a small size may be grinded, and the specific processes may be as follows.

The process of first grinding a first panel with a small size and then grinding a second panel with a big size may include first lifting the central platform 1 to be coplanar with the peripheral platform 3, with the outer-ring platform 2 being below the central platform 1, using a robotic hand to fixedly install the first panel on the central platform 1, moving the peripheral platform 3 to make an edge of the first panel to be grinded exposed out of the peripheral platform 3, using a cutter wheel to grind the burrs on the edge, with grinding liquid being sprayed onto the edges during the grinding process, after the burrs on the edge are grinded, bringing the central platform 1 to rotate by 90 degrees by the rotating base 41, such that another edge of the first panel is exposed out of the peripheral platform 3, and grinding the burrs on the other edge, until the grinding of the first panel is finished.

The process of first grinding a second panel with a big size and then grinding a first panel with a small size may include first lifting the outer-ring platform 2 and the central platform 1 to be coplanar with the peripheral platform 3, using a robotic hand to fixedly install the second panel on the central platform 1 and the outer-ring platform 2, moving the peripheral platform 3 to make an edge of the second panel to be grinded exposed out of the peripheral platform 3, using a cutter wheel to grind the burrs on the edge, with grinding liquid being sprayed onto the edge during the grinding process, after the burrs on the edge are grinded, bringing the central platform 1 and the outer-ring platform 2 to rotate by 90 degrees by the rotating base 41, such that another edge of the second panel is exposed out of the peripheral platform 3, and grinding the burrs on the other edge, until the grinding of the second panel is finished.

The process of first grinding a second panel with a big size and then grinding a first panel with a small size may include first lifting the outer-ring platform 2 and the central platform 1 to be coplanar with the peripheral platform 3, using a robotic hand to fixedly install the second panel on the central platform 1 and the outer-ring platform 2, moving the peripheral platform 3 to make an edge of the second panel to be grinded exposed out of the peripheral platform 3, using a cutter wheel to grind the burrs on the edge, with grinding liquid being sprayed onto the edge during the grinding process, after the burrs on the edge are grinded, bringing the central platform 1 and the outer-ring platform 2 to rotate by 90 degrees by the rotating base 41, such that another edge of the second panel is exposed out of the peripheral platform 3, and grinding the burrs on the other edge, until the grinding of the second panel is finished.

The process may further include, when the grinding of the second panel is finished and a first panel with a small size is to be grinded, using a robotic hand to take away the second panel from the central platform 1 and the outer-ring platform 2, and lowering the outer-ring platform 2 below the central platform 1 and the peripheral platform 3, thus finishing the automatic switch from the big-sized grinding table to the small-sized one, using the robotic hand to fixedly install the first panel on the central platform 1, moving the peripheral platform 3 to make an edge of the first panel to be grinded exposed out of the peripheral platform 3, using a cutter wheel to grind the burrs on the edge, with grinding liquid being sprayed onto the edge during the grinding process, after the burrs on the edge are grinded, bringing the central platform 1 to rotate by 90 degrees by the rotating base 41, such that another edge of the first panel is exposed out of the peripheral platform 3, and grinding the burrs on the other edge, until the grinding of the first panel is finished.

Optionally, as shown in FIG. 1, the outer-ring platform 2 includes a lifting device 22 and a first platform 23.

As shown in FIG. 1, one end of the lifting device 22 is fixed on the bottom surface of the first platform 23, and the other end thereof is fixed on the rotation base 41 of the liquid crystal display glass grinder 4. The lifting device 22 is for lifting and lowering height of the first platform 23.

As shown in FIG. 1, the central platform 1 includes a second platform 11 and a central platform supporting device 12, one end of the central platform supporting device 12 is fixed on the bottom surface of the second platform 11, and the other end thereof is fixed on the rotating base 41 of the liquid crystal display glass grinder 4, and the central platform supporting device 12 can lift or lower the second platform 11.

As shown in FIG. 1, the peripheral platform 3 include a third platform 31 and a horizontal moving device 32, one end of the horizontal moving device is fixed on the liquid crystal display glass grinder 4, and the other end thereof is fixed on the bottom surface of the third platform 31, and the horizontal moving device 32 can move the third platform 31 horizontally backwards and forwards.

When the second panel is grinded, as shown in FIG. 1, the lifting device 22 lifts the first platform 23, the central platform supporting device 12 lifts the second platform 11, until the first platform 23, the second platform 11 and the third platform 31 are coplanar, the second panel is installed on the first platform 23 and the second platform 11, the horizontal moving device 32 moves the third platform 31 horizontally to make an edge of the second panel exposed out of the third platform 31, and a cutter wheel is used to grind the edge of the second panel exposed out of the third platform 31, at this time, if it is needed to replace to grind the first panel, the lifting device 22 lowers the first platform 23 to below the second platform 11 and the third platform 31, and the first panel is installed on the second platform 11, and the horizontal moving device 32 moves the third platform 31 horizontally to make an edge of the first panel exposed out of the third platform 31, and a cutter wheel is used to grind the edge of the first panel exposed out of the third platform 31.

The lifting device 22 is used to lift and lower the first platform 23, so as to realize the lifting and lowering of the outer-ring platform 2; when the first panel and the second panel are to be replaced and grinded, the automatic switch between the big-sized grinding table and the small-sized grinding table is realized by the lifting and lowering of the central platform 1 and the outer-ring platform 2, instead of the manual switch between the big-sized grinding table and the small-sized grinding table.

Optionally, the distance by which the first panel or the second panel is exposed out of the third platform 31 is greater than or equal to 9 mm, and smaller than or equal to 10 mm. The distance may also be adjusted according to actual conditions.

Optionally, the lifting device 22 includes a screw rod and a motor.

One end of the screw rod is fixed on the bottom surface of the first platform 23, and the other end thereof is fixed on the rotating base 41 of the liquid crystal display glass grinder 4 and connected to the motor, and the motor is fixed on the rotating base 41.

the screw rod is moved upwards and downwards by the motor, so as to lift or lower the height of the first platform 23.

The other end of the screw rod may be connected to the motor of the liquid crystal display glass grinder 4 by a coupling, or may be connected to the motor of the liquid crystal display glass grinder 4 in other ways according to actual conditions. A programmable logic controller (PLC) of the liquid crystal display glass grinder 4 controls the motor, so as to control the screw rod to lift or lower the first platform 23.

The screw rod has small friction resistance to ensure the lifting and lowering movement more stable; stable. Moreover the screw rod has small wear and tear, high precision and long working life.

Optionally, the lifting device 22 is a pneumatic cylinder.

One end of the pneumatic cylinder is fixed on the bottom surface of the first platform 23, and the other end thereof is fixed on the rotating base 41 of the liquid crystals display glass grinder 4.

The height of the first platform 23 is lifted or lowered by controlling the air intake or exhaust of the pneumatic cylinder.

The programmable logic controller (PLC) of the liquid crystal display glass grinder 4 controls a solenoid valve of the pneumatic cylinder to control the air intake or exhaust of the pneumatic cylinder, so as to lift or lower the first platform 23.

The pneumatic cylinder has a simple structure and is easy to install and maintain, and can bear a big load.

Optionally, as shown in FIG. 1, the pneumatic cylinder is enclosed in a waterproof bag 5.

Enclosing the pneumatic cylinder in a waterproof bag 5 may prevent the grinding liquid which is used during grinding the panel from entering the pneumatic cylinder to affect the normal operation of the pneumatic cylinder; the waterproof bag 5 may be a ring-like extendable waterproof bag 5, and may be lifted and lowered with the pneumatic cylinder.

Optionally, as shown in FIG. 1, the number of the pneumatic cylinders may be at least 2.

The at least two pneumatic cylinders are evenly distributed and fixed on the bottom surface of the first platform 23.

The selection of the number of the pneumatic cylinders needs to ensure that when the pneumatic cylinders are raised, the first platform 23 lifted; the pneumatic cylinders being evenly distributed and fixed on the bottom surface of the first platform 23 can prevent the first platform 23 from being inclined, making the first platform 23 to be a horizontal plane, and increasing the contact area of the panel grinded and the first platform 23, so that the panel grinded is fixed on the first platform 23 more stably.

For example, when the number of the pneumatic cylinders is two, the two pneumatic cylinders may be at the two ends of the bottom surface of the first platform 23 respectively, and may be symmetric with respect to the central axis of the first platform 23. When the number of the pneumatic cylinders is four, at the two ends of the bottom surface of the first platform 23 there may be two pneumatic cylinders respectively, and the two pneumatic cylinders at one end of the first platform 23 may be symmetric to the two pneumatic cylinders at the other end with respect to the central axis of the first platform 23.

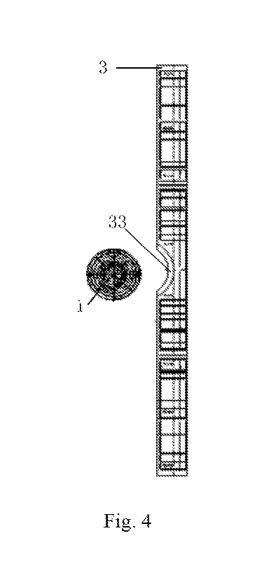

Optionally, as shown in FIG. 4, the central platform 1 is circular, and the side of the peripheral platform 3 adjacent to the central platform 1 is provided with an arc slot 33.

when the central platform 1 is lifted to be coplanar with the peripheral platform 3, the arc slot 33 of the peripheral platform 3 matches with the circular central platform 1.

The arc slot 33 of the peripheral platform 3 matches with the circular central platform 1, so as to enlarge the contact area between the peripheral platform 3, the central platform 1 and the grinded panel, and to support the grinded panel more stably.

Optionally, as shown in FIG. 2, the hallow slot 21 of the outer-ring platform 2 is a circular slot.

As shown in FIG. 3, when both of the central platform 1 and the outer-ring platform 2 are lifted to be coplanar with the peripheral platform 3, the circular central platform 1 is in the circular slot of the outer-ring platform 2.

The circular central platform 1 matches with the circular slot of the outer-ring platform 2, so as to enlarge the contact area between the central platform 1, the outer-ring platform 2 and the grinded panel, and to support the grinded panel more stably.

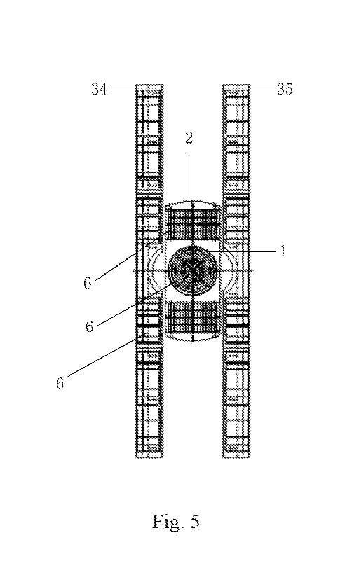

Optionally, as shown in FIG. 5, the number of the peripheral platforms 3 is two, which are a first peripheral platform 34 and a second peripheral platform 35 respectively.

the central platform 1 and the outer-ring platform 2 are located between the first peripheral platform 34 and the second peripheral platform 35.

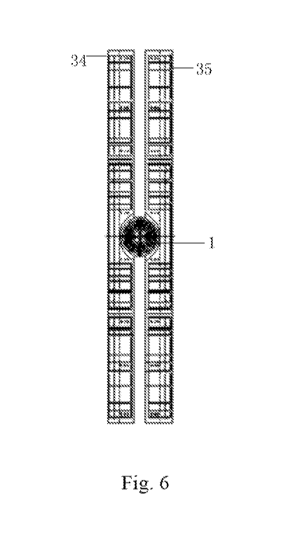

As shown in FIG. 5, when the second panel is grinded, the circular central platform 1 is in the circular slot of the outer-ring platform 2, and the first peripheral platform 34 and the second peripheral platform 35 are at the two sides of the outer-ring platform 2. As shown in FIG. 6, when the first panel is grinded, the central platform 1 is located between the first peripheral platform 34 and the second peripheral platform 35, and the arc slot 33 of the first peripheral platform 34 and the arc slot 33 of the second peripheral platform 35 match with the circular central platform 1.

Providing two peripheral platforms 3 can grind at the same time the edges of the panel exposed out of the first peripheral platform 34 and of the second peripheral platform 35, thus enhancing the grinding efficiency.

Optionally, as shown in FIG. 5, there are a plurality of holes on the central platform 1, the outer-ring platform 2, and the peripheral platform 3.

Glass scraps will be generated when a panel is grinded. If the glass scraps are left over on the central platform 1, the outer-ring platform 2 or the peripheral platform 3, when a next panel is to be grinded, the surface of the next panel may be scratched, thus affecting the surface quality of the panel. By providing a plurality of holes 6 on the central platform 1, the outer-ring platform 2, and the peripheral platform 3, the glass scraps generated during grinding the panel by the liquid crystal display glass grinder 4 may be prevented from affecting the surface quality of the panel. The size of the holes may be set depending on actual conditions.

In an embodiment of the disclosure, the central platform 1 and the outer-ring platform 2 of the grinding table apparatus are both liftable platforms. Moreover, the outer-ring platform 2 is provided with a hallow slot 21. When a first panel is to be grinded, the central platform 1 is lifted to be coplanar with the peripheral platform 3, at which time, the grinding table is the central platform 1 and is a small-sized grinding table. When a second panel is to be grinded, the outer-ring platform 2, the central platform 1 are lifted to be coplanar with the peripheral platform 3, at which time the central platform 1 and the outer-ring platform 2 form a big-sized grinding table. Thus, manual removing and installing the grinding tables when replacing the grinding tables of different sizes is not required, and the automatic switch of the big-sized grinding table and the small-sized grinding table can be finished by lifting and lowering the central platform 1 and the outer-ring platform 2, thus enhancing the manufacturing efficiency.

As shown in FIG. 1, an embodiment of the disclosure further provides a liquid crystal display glass grinder 4. The grinding table apparatus in the above embodiments is an important component of the liquid crystal display glass grinder. The liquid crystal display glass grinder further includes a rotating base 41, and the central platform 1 and the outer-ring platform 2 of the grinding table apparatus are fixed on the rotating base 41.

The central platform 1 and the outer-ring platform 2 of the liquid crystal display glass grinder 4 in an embodiment of the disclosure are both liftable platforms. Moreover, the outer-ring platform 2 is provided with a hallow slot 21. When a first panel is to be grinded, the central platform 1 is lifted to be coplanar with the peripheral platform 3, at which time the grinding table is the central platform 1 and is a small-sized grinding table. When a second panel is to be grinded, the outer-ring platform 2 and the central platform 1 are lifted to be coplanar with the peripheral platform 3, at which time the central platform 1 and the outer-ring platform form the big-sized grinding table. Thus, manual removing and installing the grinding tables when replacing the grinding tables of different sizes is not required, and the automatic switch of the big-sized grinding table and the small-sized grinding table can be finished by lifting and lowering the central platform 1 and the outer-ring platform 2, thus enhancing the manufacturing efficiency.

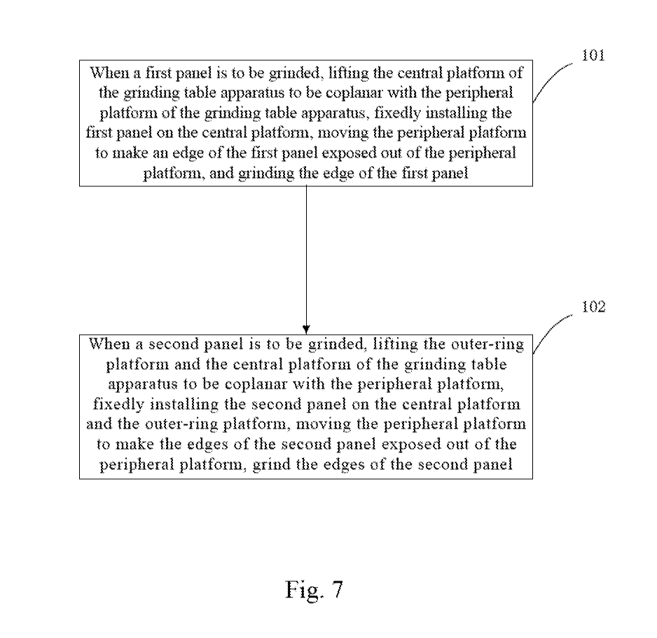

An embodiment of the disclosure provides a grinding method of a grinding table apparatus, and the grinding method is used to grind a first panel and a second panel, the first panel being smaller than the second panel, the grinding apparatus in this embodiment is provided with two peripheral platforms 3, and in this embodiments, by taking first grinding the first panel and then grinding the second panel as an example, the method flow is as shown in FIG. 7:

Step 101: when a first panel is to be grinded, lifting the central platform 1 of the grinding table apparatus to be coplanar with the peripheral platform 3 of the grinding table apparatus, fixedly installing the first panel on the central platform 1, moving the peripheral platform 3 to make an edge of the first panel exposed out of the peripheral platform 3, and grinding the edge of the first panel.

Optionally, step 101 may specifically include lifting the central platform 1 to be coplanar with the peripheral platform 3, using a robotic hand to fix the first panel on the central platform 1, horizontally moving the peripheral platform 3, to make the two edges of the first panel to be grinded exposed out of the peripheral platform 3 by a certain distance, spraying grinding liquid and grinding the two edges of the first panel exposed out of the peripheral platform 3, stopping spraying the grinding liquid and lifting the central platform 1, rotating the central platform 1 by 90 degrees, and lowering the central platform 1 to be coplanar with the peripheral platform 3, horizontally moving the peripheral platform 3, to make other two edges of the first panel to be grinded exposed out of the peripheral platform 3 by a certain distance, spraying grinding liquid and grinding the other two edges of the first panel exposed out of the peripheral platform 3, and stopping spraying the grinding liquid and using a robotic hand to remove the grinded first panel from the machine tool.

Step 102: when a second panel is to be grinded, lifting the outer-ring platform 2 and the central platform 1 of the grinding table apparatus to be coplanar with the peripheral platform 3, fixedly installing the second panel on the central platform 1 and the outer-ring platform 2, moving the peripheral platform 3 to make edges of the second panel exposed out of the peripheral platform 3, grinding the edges of the second panel.

Optionally, step 102 may specifically include horizontally moving the peripheral platform 3, to preserve sufficient space for the outer-ring platform 2, lifting the outer-ring platform 2 and the central platform 1 to be coplanar with the peripheral platform 3, using a robotic hand to fix the second panel on the central platform 1 and the outer-ring platform 2, horizontally moving the peripheral platform 3, to make the two edges of the second panel to be grinded exposed out of the peripheral platform 3 by a certain distance, spraying grinding liquid and grind the two edges of the second panel exposed out of the peripheral platform 3, stopping spraying the grinding liquid and lifting the central platform 1 and the outer-ring platform 2, rotating simultaneously the central platform 1 and the outer-ring platform 2 by 90 degrees, and lowering the central platform 1 and the outer-ring platform 2 to be coplanar with the peripheral 3, horizontally moving the peripheral platform 3, to make the other two edges of the second panel to be grinded exposed out of the peripheral platform 3 by a certain distance, spraying grinding liquid and grinding the other two edges of the second panel exposed out of the peripheral platform 3, and stopping spraying the grinding liquid and using a robotic hand to remove the grinded second panel from the machine tool.

An embodiment of the disclosure provides a grinding method, wherein the grinding table apparatus first grinds the second panel and then grinds the first panel, including lifting the outer-ring platform 2 and the central platform 1 of the grinder to be coplanar with the peripheral platform 3, fixedly installing the second panel on the central platform 1 and the outer-ring platform 2, moving the peripheral platform 3 to make edges of the second panel exposed out of the peripheral platform 3, grinding the edges of the second panel, when the second panel has been grinded, using a robotic hand to remove the second panel from the machine tool, lowering the outer-ring platform 2 below the central platform 1 and the peripheral platform 3, fixedly installing the first panel on the central platform 1, moving the peripheral platform 3 to make edges of the first panel exposed out of the peripheral platform 3, and grinding the edges of the first panel.

The central platform 1 and the outer-ring platform of the grinding table apparatus in this embodiment of the disclosure are both liftable platforms. The outer-ring platform 2 is provided with a hallow slot 21. When a first panel is to be grinded, lifting the central platform 1 to be coplanar with the peripheral platform 3, at which time the grinding table is the central platform 1 and is a small grinding table. When a second panel is to be grinded, lifting the outer-ring platform 2 and the central platform 1 to be coplanar with the peripheral platform 3, at which time, the central platform 1 and the outer-ring platform 2 form a big grinding table. Thus, it is not needed to manually remove and install the grinding tables when the grinding tables of different sizes are replaced, and the automatic switch of the big-sized grinding table and the small-sized grinding table can be realized by lifting and lowering the central platform 1 and the outer-ring platform 2, thus enhancing the manufacturing efficiency.

The description above merely discusses example embodiments of the disclosure, which shall not be used to limit the scope of the disclosure. Any amendments, equivalent replacements and improvement made within the spirit and principles of the disclosure should be included in the protection scope of the disclosure.

1. A grinding table apparatus comprising a liftable central platform, a liftable outer-ring platform, and a peripheral platform, wherein:
the outer-ring platform is provided with a hollow slot, and the central platform is configured to be in the hollow slot of the outer-ring platform, the central platform and the outer-ring platform being at one side of the peripheral platform;
when the central platform is lifted to be coplanar with the peripheral platform, a first panel is configured to be fixedly installed on the central platform, and the peripheral platform is configured to be moved such that an edge of the first panel is exposed out of the peripheral platform; and
when the central platform and the outer-ring platform are both lifted to be coplanar with the peripheral platform, a second panel is configured to be fixedly installed on the central platform and the outer-ring platform, and the peripheral platform is configured to be moved such that an edge of the second panel is exposed out of the peripheral platform, the first panel being smaller than the second panel.

2. The grinding table apparatus of claim 1, wherein:
the outer-ring platform comprises a lifting device and a first platform;
one end of the lifting device is fixed on a bottom surface of the first platform, and another end, opposite the one end, of the lifting device is fixed on a rotating base of a liquid crystal display glass grinder; and
the lifting device is configured to lift the height of the first platform.

3. The grinding table apparatus of claim 2, wherein:
the lifting device comprises a screw rod and a motor;
one end of the screw rod is fixed on the bottom surface of the first platform, and another end, opposite the one end, of the screw rod is fixed on the rotating base of the liquid crystal display glass grinder and connected to the motor, the motor being fixed on the rotating base;
the motor is configured to drive the screw rod to move upwards or downwards, such that the screw rod lifts or lowers the first platform.

4. The grinding table apparatus of claim 2, wherein:
the lifting device is a pneumatic cylinder;
one end of the pneumatic cylinder is fixed on the bottom surface of the first platform, and another end, opposite the one end, of the pneumatic cylinder is fixed on the rotating base of the liquid crystal display glass grinder; and
the first platform is configured to be lifted or lowered by controlling an air-intake or an exhaust of the pneumatic cylinder.

5. The grinding table apparatus of claim 4, wherein the pneumatic cylinder is enclosed in a water-proof bag.

6. The grinding table apparatus of claim 4, wherein:
the number of the pneumatic cylinders is at least two; and
the at least two pneumatic cylinders are evenly distributed and fixed on the bottom surface of the first platform.

7. The grinding table apparatus of claim 1, wherein:
the central platform is circular;
the side of the peripheral platform adjacent to the central platform is includes an arc slot; and,
the central platform is liftable into a coplanar relationship with the peripheral platform, such that the arc slot of the peripheral platform matches with the circular central platform.

8. The grinding table apparatus of claim 7, wherein:
the hallow slot of the outer-ring platform is a circular slot; and,
the central platform and the outer-ring platform are both liftable into a coplanar relationship with the peripheral platform, such that the circular central platform is in the circular slot of the outer-ring platform.

9. The grinding table apparatus of claim 1, wherein:
the number of the peripheral platforms is two, which are a first peripheral platform and a second peripheral platform respectively; and
the central platform and the outer-ring platform are located between the first peripheral platform and the second peripheral platform.

10. The grinding table apparatus of claim 1, wherein the central platform, the outer-ring platform and the peripheral platform are include a plurality of holes.

11. A liquid crystal display glass grinder, wherein the liquid crystal display glass grinder comprises the grinding table apparatus of claim 1.

12. The liquid crystal display glass grinder of claim 11, wherein:
the outer-ring platform comprises a lifting device and a first platform; and
one end of the lifting device is fixed on a bottom surface of the first platform, and another end, opposite the one end, is fixed on a rotating base of a liquid crystal display glass grinder;
the lifting device is configured to lift the first platform.

13. The liquid crystal display glass grinder of claim 12, wherein:
the lifting device comprises a screw rod and a motor;
one end of the screw rod is fixed on the bottom surface of the first platform; and
another end, opposite the one end, is fixed on the rotating base of the liquid crystal display glass grinder; and
the motor is configured to drive the screw rod to move upwards or downwards, such that the screw rod lifts or lowers the first platform.

14. The liquid crystal display glass grinder of claim 12, wherein:
the lifting device is a pneumatic cylinder;
one end of the pneumatic cylinder is fixed on the bottom surface of the first platform;
the another end, opposite the one end, is fixed on the rotating base of the liquid crystal display glass grinder; and
the first platform is configured to be lifted or lowered by controlling an air-intake or an exhaust of the pneumatic cylinder.

15. The liquid crystal display glass grinder of claim 14, wherein the pneumatic cylinder is enclosed in a water-proof bag.

16. The liquid crystal display glass grinder of claim 14, wherein:
the number of the pneumatic cylinders is at least two; and
the at least two pneumatic cylinders are evenly distributed and fixed on the bottom surface of the first platform.

17. The liquid crystal display glass grinder of claim 11, wherein:
the central platform is circular;
the side of the peripheral platform adjacent to the central platform is includes an arc slot; and,
the central platform is liftable into a coplanar relationship with the peripheral platform, such that the arc slot of the peripheral platform matches with the circular central platform.

18. The liquid crystal display glass grinder of claim 11, wherein:
the number of the peripheral platforms is two, which are a first peripheral platform and a second peripheral platform respectively; and
the central platform and the outer-ring platform are located between the first peripheral platform and the second peripheral platform.

19. The liquid crystal display glass grinder of claim 11, wherein the central platform, the outer-ring platform and the peripheral platform include a plurality of holes.

20. A grinding method of the grinding table apparatus of claim 1, wherein the method is used for grinding a first panel and a second panel, the first panel being smaller than the second panel, comprising:
lifting the central platform of the grinding table apparatus to be coplanar with an peripheral platform of the grinding table apparatus, fixedly installing the first panel on the central platform, moving the peripheral platform such that an edge of the first panel is exposed out of the peripheral platform, and grinding the edge of the first panel; and
lifting the outer-ring platform and the central platform of the grinding table apparatus to be coplanar with the peripheral platform, fixedly installing the second panel on the central platform and the outer-ring platform, moving the peripheral platform such that an edge of the second panel is exposed out of the peripheral platform, and grinding the edge of the second panel.
